(19) United States
(12) Patent Application Publication
(10) Pub. No.: US 2005/0098971 A1
(43) Pub. Date: May 12, 2005

(54) Trolley

(76) Inventor: Michael Walsh, Willow Tree, NSW (AU)

Correspondence Address: SEYFARTH SHAW, 55 EAST MONROE STREET, SUITE 4200, CHICAGO, IL, 60603-5803, US

(21) Appl. No.: 10/450,317

(22) PCT Filed: Dec. 12, 2001
(86) PCT No.: PCT/AU01/01608

(30) Foreign Application Priority Data
Dec. 12, 2000 (AU) 72196/00

(51) Int. Cl. B62B 3/00

(52) U.S. Cl. 280/47.371; 280/79.3

(57) ABSTRACT

Flat trolley is suitable for moving heavy objects, eg furniture. It has central retractable strap for securing an object to trolley and loops at respective ends to enable trolley to be manually pulled, carried up stairs, etc. Flexible loops have respective pairs of retractors which allow human operators to slowly extend loops so they can be placed over the operators' shoulders. Sharp tuggins on loops however locks retractors allowing the object and trolley to then be carried using loops.

### FIELD OF THE INVENTION

The present invention relates to a trolley for moving items and, particularly, but not exclusively, to a trolley for use in the removals industry and furniture retail industry.

### BACKGROUND OF THE INVENTION

In the removals industry, it is often necessary to transport heavy and/or cumbersome items from one location to another. At present, one way to achieve this is to use a trolley which includes a frame and a plurality of wheels, the item being disposed on the frame and moved by pushing the frame. While such a trolley is satisfactory in transporting items in a generally straight line along generally flat terrain, the trolley is not particularly suitable for manoeuvring an item around corners or in confined spaces, or for transporting an item between different terrain levels.

In order to transport an item between different terrain levels, the item must be lifted, generally by two operators. To assist in lifting an item, it is normal to provide each operator with a link which forms a continuous loop. During use each link extends around the neck of an operator and extends beneath an underside portion of the item. In this way, the weight of the item is borne by the shoulders of the operators and the risk of damage to the back of each operator is reduced.

However, such a lifting arrangement is unsafe since a link can slip from beneath the item, potentially causing injury to an operator, damage to the item and/or damage to the dwelling from which or to which the item is being transported. The link is also cumbersome for the user since to obtain comfortable lifting, it is necessary for the length of the link to be modified by manual adjustment to best suit the height of the operator.

### SUMMARY OF THE INVENTION

In accordance with the present invention, there is provided a trolley including a frame, a first lifting arrangement located adjacent a first end of the frame, and a second lifting arrangement located adjacent a second opposite end of the frame, each of the first and second lifting arrangements including a first flexible member connected to the frame at spaced locations on the frame so as to define a loop, and at least one first retractor mounted to the frame, each at least one first retractor being associated with a first flexible member and each at least one first retractor being arranged to allow its associated first flexible member to withdraw from the first retractor when the first flexible member is withdrawn at a speed which is below a predetermined speed, and to lock the first flexible member and prevent further withdrawal when the first flexible member is withdrawn at a speed which exceeds the predetermined speed, the arrangement being such that each first flexible member is selectively adjustable in length and selectively lockable to restrain or permit enlargement of the first flexible member.

The first and/or second lifting arrangement preferably includes two first retractors mounted to the frame at spaced locations. Each first retractor may be mounted on a platform fixed to the frame.

The frame may include at least one strengthening plate which may extend between opposite side members of the frame or opposite end members of the frame.

The trolley may also include a restraining arrangement for facilitating retaining of an item on the trolley. Preferably, the restraining arrangement includes a second retractor, a second flexible member associated with the second retractor, a first attachment portion provided on the frame, and a second attachment portion attached to an end of the second flexible member remote from the second retractor, the second attachment portion being adapted to engage with the first attachment portion. Preferably, the second attachment portion includes a male buckle portion and the first attachment portion includes a female buckle portion adapted to engage with the male buckle portion.

The restraining arrangement may also include tensioning means, preferably in the form of an over centre arrangement, for applying tension to the second flexible member when the male buckle portion is engaged with the female buckle portion.

The trolley preferably also includes a plurality of castors, each castor including a rotatable wheel. Preferably, each wheel is formed of rubber material.

### BRIEF DESCRIPTION OF THE DRAWINGS

The present invention will now be described, by way of example only, with reference to the accompanying drawings, in which:

FIG. 1 is a diagrammatic upper plan view of a trolley in accordance with the present invention;

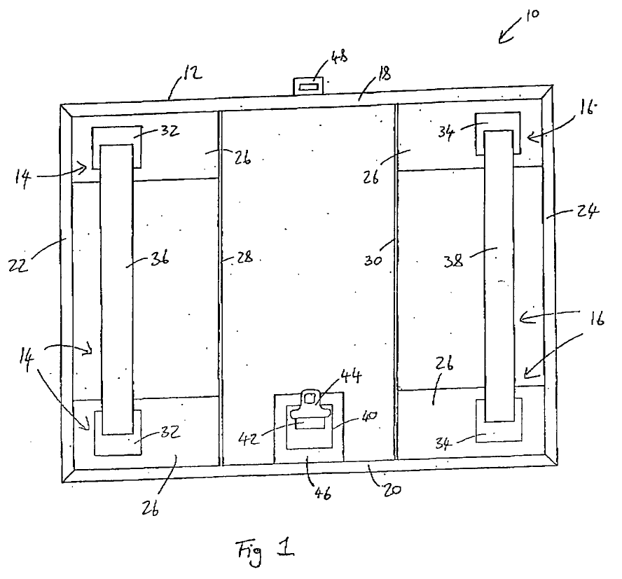

FIG. 2 is a diagrammatic lower plan view of the trolley shown in FIG. 1; and

FIGS. 3a to 3c are diagrammatic cross-sectional views of a portion of a frame of the trolley shown in FIGS. 1 and 2.

### DETAILED DESCRIPTION OF AN EMBODIMENT OF THE INVENTION

Referring to the drawings, there is shown a trolley 10 for use in the removals industry.

The trolley 10 includes a frame 12 formed of suitably strong, light material such as aluminium, a first lifting arrangement 14 located adjacent a first end of the trolley 10, and a second lifting arrangement 16 located adjacent a second opposite end of the trolley 10.

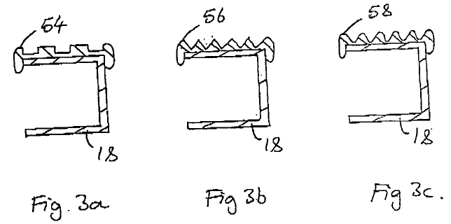

The frame 12 includes longitudinal first and second side members 18, 20 and transverse first and second end members 22, 24 respectively. Each of the first and second side members 18, 20 and each of the first and second end members 22, 24 is of generally rectangular or C-shaped cross section, as shown in FIGS. 3a to 3c. Each side member 18, 20 abuts an adjacent end member 22, 24 at a corner of the frame 12, where the side members 18, 20 and end members 22, 24 may be fixed together, for example by welding.

The frame 12 also includes four first platforms 26, each of which is fixed adjacent an interior corner of the frame 12. The first platforms 26 serve to support the first and second lifting arrangements 14, 16.

The frame 12 also includes first and second strengthening plates 28, 30 which extend between the first and second side members 18, 20. The first and second strengthening plates 28, 30 may be fixed to the side plates 18, 20 and/or the first platforms 26, for example by welding.

The first lifting arrangement 14 includes a pair of first retractors 32 and the second lifting arrangement 16 includes a pair of first retractors 34, each of the first retractors 32, 34 being mounted on a first platform 26. A first link, in this example in the form of a first strap 36 extends between the pair of first retractors 32. Likewise, a second link in the form of a second strap 38 extends between the pair of first retractors 34.

It will be understood that each first retractor 32, 34 operates in a similar way to a retractor of a vehicle seatbelt, that is, each first retractor 32, 34 allows its associated strap 36, 38 to withdraw from the first retractor when the strap is withdrawn at a speed which is below a predetermined speed, and the first retractor locks the strap and withdrawal is not permitted when the strap is withdrawn at a speed which exceeds the predetermined speed.

Accordingly, by providing each of the first and second lifting arrangements 14, 16 with a pair of first retractors 32, 34 and a strap 26,38 extending between the first retractors, a loop of variable size is obtained. In this way, the operators are provided with a lifting strap 36, 38 which may be easily adjusted to suit the operators height.

It will also be understood that since the straps 36, 38 are fixed to the frame 12 by virtue of the retractors 32, 34, there is no possibility that the straps 36, 38 will detach from the frame 12 and cause injury to the operators, damage to the item being carried and/or damage to the surrounding dwelling.

The trolley 10 also includes a restraining arrangement for facilitating retaining of an item on the trolley 10 during a moving operation.

The restraining arrangement includes a second retractor 40, a restraining strap 42 associated with the second retractor 40 and a male buckle portion 44 connected to the restraining strap 42. The second retractor 40 is mounted on a second platform 46 fixed to the second side member 20, for example by welding.

It will be understood that the second retractor 40 operates in a similar way to the first retractors 32, 34. In other words, the restraining strap 42 and thereby the male buckle portion 42 are withdrawable from the second retractor 40 when the restraining strap 42 is withdrawn at a speed below a predetermined speed, and the second retractor 40 locks the strap and withdrawal is not permitted when the restraining strap 42 is withdrawn at a speed which exceeds the predetermined speed.

The restraining arrangement also includes a female buckle portion 48, in this example fixed to a side surface of the first side member 18, for example by bolting. The male buckle portion 42 is adapted to engage with the female buckle portion 48.

The restraining arrangement may also include tensioning means, for example in the form of an over centre arrangement which serves to apply tension to the restraining strap 42 when the restraining strap 42 has been drawn around the item and engaged with the female buckle portion 48.

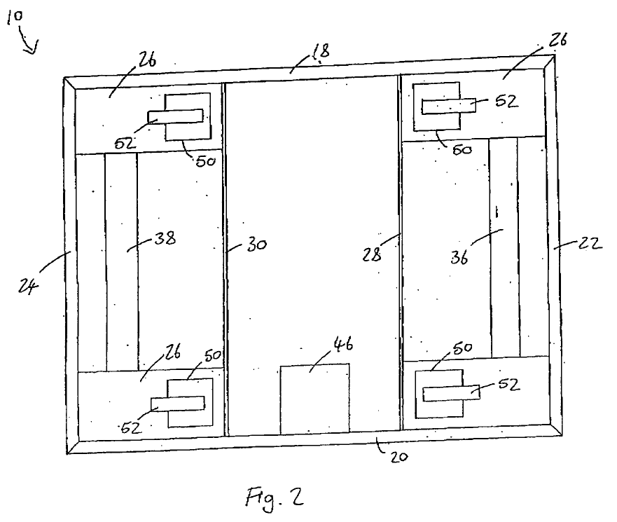

As shown in FIG. 2, the trolley 10 also includes four castors 50, each of which includes a rotatable wheel 52 which in this example is formed of hard rubber. Each castor 50 also includes a braking mechanism for selectively preventing or allowing rotation of its associated wheel 52.

It will be understood that the castors 50 facilitate easy turning and ensure good manoeuvrability of the trolley 10.

As shown in FIGS. 3a to 3c, the side members 18, 20 and end members 22, 24 of the frame 12 may include a cap 54, 56, 58, in this example formed of hard rubber. The cap 54, 56, 58 serves to prevent damage to the item when the item is located on the trolley 10 and restrained relative to the trolley 10 by the restraining arrangement.

In use, the trolley 10 operates as follows.

An item to be transported is placed on the trolley 10 such that the item sits on the cap 54, 56, 58. The restraining strap 42 is then withdrawn from the second retractor 42 at a speed below the predetermined speed so that the restraining strap 42 does not lock, the strap 42 is drawn around the item, and the male buckle portion 44 is engaged with the female buckle portion 48. Tension is then applied to the restraining strap 42 by the over centre arrangement.

To move the trolley 10 over generally even terrain, the first or second strap 36, 38 may be used to pull the trolley, it being possible to manoeuvre the trolley 10 around confined spaces by virtue of the rotatable wheels 52 of the castors 50.

To lift the item between different levels of terrain, each operator withdraws a strap from its respective first retractors 32, 34 at a speed below the predetermined speed so that the strap does not lock, and places the strap over the operators shoulders. Once the operators have determined the most suitable length for the respective strap 36, 38, the strap is jerked by the operator away from the respective retractors 32, 34 so as to briefly withdraw the respective strap 36, 38 at a speed greater than the predetermined speed and thereby lock the respective strap. The operators are now able to stand fully erect so as to lift the trolley 10 and thereby the item.

It will be appreciated that the first and second straps 36, 38 are withdrawable to a length sufficient to allow an operator to pull the trolley 10 up a ramp, for example towards a truck. This allows the operator to remain in the truck whilst the trolley 10 and associated item is moved into the truck, thereby avoiding the need for the operator to stand on the ramp which is potentially hazardous.

Although the trolley is described above as being particularly suited for use in the removals industry and furniture retail industry for shifting furniture, it will be appreciated that it may be useable in other industries to move items and is not restricted to the removals and furniture retail industry.

Modifications and variations as would be apparent to a skilled addressee are deemed to be within the scope of the present invention.

1. A trolley including a frame, a first lifting arrangement located adjacent a first end of the frame, and a second lifting arrangement located adjacent a second opposite end of the frame, each of the first and second lifting arrangements including a first flexible member connected to the frame at spaced locations on the frame so as to define a loop, and at least one first retractor mounted to the frame, each at least one first retractor being associated with a first flexible member and each at least one first retractor being arranged to allow its associated first flexible member to withdraw from the first retractor when the first flexible member is withdrawn at a speed which is below a predetermined speed, and to lock the first flexible member and prevent further withdrawal when the first flexible member is withdrawn at a speed which exceeds the predetermined speed, the arrangement being such that each first flexible member is selectively adjustable in length and selectively lockable to restrain or permit enlargement of the first flexible member.

2. A trolley as claimed in claim 1, wherein each lifting arrangement includes two first retractors mounted to the frame at spaced locations on the frame.

3. A trolley as claimed in claim 2, wherein each lifting arrangement is mounted on at least one platform.

4. A trolley as claimed in claim 1, further including at least one strengthening plate.

5. A trolley as claimed in claim 4, wherein the frame is defined by two opposite side members and two opposite end members, and the at least one strengthening plate extends between the side members and/or between the end members.

6. The trolley of claim 1, further including a restraining arrangement for facilitating retaining of an item on the trolley.

7. A trolley as claimed in claim 6, wherein the restraining arrangement includes a second retractor, a second flexible member associated with the second retractor, a first attachment portion provided on the frame, and a second attachment portion attached to an end of the second flexible member remote from the second retractor, the second attachment portion being adapted to engage with the first attachment portion.

8. A trolley as claimed in claim 7, wherein the second attachment portion includes a male buckle portion and the first attachment portion includes a female buckle portion.

9. A trolley as claimed in claim 7, wherein the restraining arrangement includes tensioning means for applying tension to the second flexible member when the first attachment portion is engaged with the second attachment portion.

10. A trolley as claimed in claim 8, wherein the second flexible member is a strap.

11. The trolley of claim 7, wherein the first flexible member is a strap.

12. The trolley of claim 7, further including a plurality of castors.

13. (canceled)

14. A trolley as claimed in claim 7, wherein the second flexible member is a strap.
